(19) United States
(12) Patent Application Publication
(10) Pub. No.: US 2024/0051435 A1
(43) Pub. Date: Feb. 15, 2024

(54) SEMI-INTEGRATED SEAT

(71) Applicant: AUTOMOBILI LAMBORGHINI S.P.A., Sant'Agata Bolognese (IT)

(72) Inventor: Enrico MASTROIANNI, Bologna (IT)

(21) Appl. No.: 18/255,987

(22) PCT Filed: Dec. 17, 2021
(86) PCT No.: PCT/IB2021/061920

§ 371 Date: Jun. 5, 2023

(30) Foreign Application Priority Data
Dec. 22, 2020 (IT) 102020000031922

(51) Int. Cl. B60N 2/22; B60N 2/015

(52) U.S. Cl. CPC B60N 2/22; B60N 2/015

(57) ABSTRACT

A vehicle comprises an interior delimited, at least partly, by a bottom wall and a rear wall and at least one seat mounted inside the interior; the seat includes sitting portion and a backrest, disconnected from the sitting portion; the sitting portion is connected directly to the bottom wall and the backrest is connected to the rear wall by a supporting system; the backrest is movable along the sitting portion by means of the supporting system between a retracted position and a forward position and the bottom wall is configured in such a way that, in use, when the backrest is at the retracted position a user is seated lower down on the sitting portion than when the backrest is at the forward position.

### TECHNICAL FIELD

This invention relates to a vehicle seat and, more specifically, to a seat preferably intended for sports or super sports cars, two-seaters in particular.

### BACKGROUND ART

Most car seats can be divided substantially into standard seats, which are used in the majority of vehicles, and sports seats, which are used in sports and super sports cars, including those of the type known as one-off or few-off.

SAE J4002 defines what is known as the H-point of the seat and what is known as the H-point Travel Path, which is the locus of all the H-points in the seat adjustment range.

Standard seats comprise a sitting portion and a backrest articulated to the sitting portion by a reclining system to allow adjusting at least the inclination of the backrest relative to the sitting portion.

The seat is generally connected to the vehicle by a slider system including suitable guides positioned between the sitting portion and the vehicle.

The slider and reclining system allow the driver to find the driving position most suitable for them with reference, for example, to the vehicle controls and the line of vision through the windscreen, also taking into consideration the fact that modern seats are usually also provided with a height adjustment device.

In the case of standard seats, also provided with a height adjustment system, the H-point travel path thus has the shape of a parallelogram and the user, specifically the driver, can adjust the driving position by positioning the seat so that the H-point is anywhere along the respective H-point travel path.

One drawback of seats of this kind is their weight, made worse by the presence of the slider, reclining and lifting systems, and their overall dimensions, also on account of these same systems; moreover, the seat may not be perfectly integrated in the vehicle.

In sports seats, in particular, as mentioned above, those intended for one-off and few-off sports and super sports cars, the sitting portion and the backrest are made in one piece and the sitting portion is fixed directly to the vehicle, for example, to a shell that is part of the vehicle; the H-point of these seats is fixed at a single position.

Seats of this kind are therefore very light and allow the user to be seated as low as possible, even directly on the car shell.

Disadvantageously, the comfort of these sports seats is limited, in that users of different heights and builds are all restricted to a single seat position and H-point, determined at the design stage.

Fixed seats do not allow optimizing the position relative to the vehicle controls and, precisely for this reason, in cars provided with seats of this kind, at least the pedals are usually adjustable in position.

Moreover, sports seats fixed to the vehicle do not allow adjusting the position of the user's viewing point which may be, for example, too low, too high, too far forward or too far back, depending on the user's build or height.

To at least partly overcome these drawbacks, car manufacturers that adopt seats of this kind provide booster cushions of different sizes to allow the position of the H-point to be changed at least vertically; replacing the booster cushion each time a different user/driver takes the wheel is not very practical, however.

Document JPS63147326U describes a seat in which the sitting portion and the backrest are joined to each other by a load-bearing structure to which both are connected and in which the position of the backrest is adjustable relative to the shell, hence relative to the sitting portion.

In the automobile sector, in particular, that of sports cars and the like, there continues to be a need for a lightweight seat that is fixable to the vehicle shell and that will allow a person, irrespective of height and build, to be seated in an optimum position relative to the vehicle controls and in terms of that person's viewing point relative to the windscreen.

In this context, our intention is to propose a seat that is capable of overcoming at least some of the drawbacks of the prior art and of meeting the above mentioned need.

### Aim of the Invention

More specifically, this invention has for an aim to provide a lightweight seat which allows its user to sit in the vehicle in an optimum position, irrespective of the user's height and build.

This aim is achieved by a seat comprising the technical features described in one or more of the accompanying claims. The dependent claims correspond to possible different embodiments of the invention.

According to a first aspect, this invention regards a sports car seat comprising a sitting portion and a backrest which is disconnected from the sitting portion.

According to an aspect, the seat is fixable to the vehicle independently of the backrest. The seat comprises a backrest supporting system configured for installing the backrest in the vehicle and supporting the backrest. According to an aspect, the backrest is movable along the sitting portion, by means of the supporting system, between a retracted position and a forward position.

That way, the H-point of the seat remains fixed relative to the backrest but moves relative to the sitting portion based on the position of the backrest.

Preferably, the forward position and the retracted position are identified by a front face of the backrest.

In an embodiment, the supporting system is fixed to a rear face of the backrest.

In an embodiment, the sitting portion comprises a supporting part for supporting a user's buttocks; when the backrest is at the forward position, the supporting part has a height, relative to a horizontal reference, that is greater than a height it has when the backrest is at the retracted position.

Preferably, the height of the supporting part relative to the horizontal reference increases as the backrest moves from the retracted position to the forward position.

In an embodiment, at least the supporting part extends on an inclined plane or on a curved surface which can be approximated to an inclined plane.

The H-point travel path is a straight line segment that is parallel to the aforesaid inclined plane.

According to an aspect, the sitting portion comprises a supporting part for supporting at least part of the legs of the user of the seat; the leg supporting part is preferably greater in length when the backrest is at the retracted position than when the backrest is at the forward position.

In an embodiment, the seat comprises a supporting structure to support at least the first supporting part; preferably, the sitting portion is supported by the supporting part.

According to an aspect, when the backrest is at the forward position, the supporting structure has a height that is greater than a height it has when the backrest is at the retracted position.

The total slope of the supporting part is determined by the slope and shape of the sitting portion and/or the slope of the supporting structure.

In an embodiment, the supporting structure is level, flat, substantially horizontal, and the slope of the part that supports the buttocks depends on the shape of the supporting structure, specifically of the sitting portion. In an embodiment, the sitting portion is substantially level and is coupled to a supporting structure that determines the slope and height, relative to a horizontal reference, of the supporting part that supports the buttocks. In an embodiment, the slope and height of the supporting part that supports the buttocks are determined by a combination of the slopes of the sitting portion and of the supporting structure that supports the sitting portion. According to an aspect, the height of the supporting structure relative to a horizontal reference increases as the backrest moves from the retracted position to the forward position.

According to an aspect, the supporting structure extends at least partly along an inclined plane; the sitting portion is preferably fixed to the inclined plane.

Generally speaking, the shape of the sitting portion and/or of the supporting part, specifically their slope, determines the H-point travel path of the seat in the vehicle interior as a function of the position of the backrest relative to the sitting portion.

According to an aspect, the supporting structure at least partly defines a housing compartment under the sitting portion.

According to an aspect, there is provided a vehicle, preferably a sports or super sports car, comprising an interior delimited at least partly by a bottom wall and a rear wall.

The car comprises a seat that comprises a sitting portion, a backrest disconnected from the sitting portion and a backrest supporting system configured for installing the backrest in the vehicle and supporting the backrest.

According to an aspect, the seat is mounted inside the car interior, the sitting portion is connected to the bottom wall and the backrest is connected to the rear wall by the supporting system.

The backrest is movable along the sitting portion, by means of the supporting system, between a retracted position and a forward position.

The seat may be according to one or more of the aspects and embodiments described in the foregoing.

That way, the H-point of the seat remains fixed relative to the backrest but moves relative to the sitting portion based on the position of the backrest and the H-point travel path in the vehicle is thus defined by a straight line segment.

According to an aspect, the H-point travel path of the seat is a function of at least two height percentiles of a reference population.

According to an aspect, the vehicle comprises a supporting structure for supporting at least the first supporting part and/or the sitting portion of the seat.

The supporting structure in the car may correspond to the supporting structure which supports the sitting portion of the seat and which is provided in the car interior.

In an embodiment, the supporting structure provided in the car is distinct from the supporting structure which is provided in the seat and the position of the sitting portion is determined by the combination of the two.

According to an aspect, the bottom wall of the car interior at least partly defines the supporting structure of the sitting portion for supporting at least one supporting part.

According to an aspect, at least the sitting portion of the seat is supported by the second supporting structure.

According to an aspect, when the backrest is at the forward position, the sitting portion supporting structure provided in the car has a height that is greater than a height it has when the backrest is at the retracted position.

According to an aspect, the height, relative to a horizontal reference, of the supporting structure provided in the car increases as the backrest moves from the retracted position to the forward position.

According to an aspect, the supporting structure provided in the car extends at least partly along an inclined plane; the sitting portion of the seat is fixed to the inclined plane and is also inclined.

According to an aspect, the supporting structure provided in the car defines a housing compartment under the sitting portion.

According to an aspect, the super sports car comprises a shell, made preferably from composite materials, and the bottom wall is part of the shell.

According to an aspect, the car shell is shaped and configured also to define the seat supporting structure so that the sitting portion is in contact with the bottom of the car in the most effective way possible, for example, for sporty driving.

According to an aspect, in the vehicle, the H-point travel path of the seat is a straight line segment that is a function of at least two height percentiles of a reference population.

According to an aspect, this disclosure relates to a seat comprising a sitting portion and a backrest with an upper end part that is movable between a first working position and a second working position that is reclined relative to the first working position. That way, it is possible to access a space which may be obstructed by the upper end part at the first working position but which becomes accessible when the upper end part is at the second working position.

In an embodiment, when it is at the second working position, the upper end part is inclined towards the sitting portion.

The seat according to one or more of the above aspects combines the advantages of a standard seat with those of a sports seat.

The sitting portion may be fixed directly to the shell and is inclined in such a way as to allow users of different heights to have each their own specific viewing point in an optimum position in the car interior, depending on how the backrest is positioned relative to the sitting portion.

The locus of the viewing points of the users can sweep an ellipse, based also on user build.

In the case where the H-point travel path of the seat approximates the curve of the main height percentiles of a reference population, the locus of the viewing points of the different users is even more satisfactory for different user body heights.

The sitting portion of the seat provides better support for the user's legs, since the space available, in particular in height, depends on the position of the backrest.

The sitting portion is shorter for low percentiles and progressively increases as the percentiles get higher, based on the position of the backrest, whereas in standard seats or in sports seats, the length of the sitting portion is a compromise that cannot suit the leg length of different users.

The sitting portion is high for low percentiles and gets progressively lower as the percentiles get higher.

The seat allows an additional space to be created under the sitting portion, in particular in the case where the bottom wall of the car is shaped in such a way as to contribute to obtaining the slope of the sitting portion itself.

This additional space may remain available inside the car to accommodate batteries, in particular in HEV/PHEV/EV vehicles and to accommodate a tank or an electronic control unit.

The seat can allow the driving position to be made lower if required by car design specifications and, more specifically, the driver can sit lower down compared to a standard seat, thanks to the absence of a supporting structure that slides on rails between the sitting portion and the bottom of the car in the case of a fully integrated seat.

The seat is lighter in weight than a standard sea, since the adjustment mechanisms apply only to the backrest and not to the sitting portion.

Further features and advantages of the foregoing, and additional aspects thereof, are more apparent in the exemplary, hence non-limiting, description of several preferred but non-exclusive embodiments of a sports car seat and of a car comprising such a seat.

### BRIEF DESCRIPTION OF THE DRAWINGS

The description is set out below with reference to the accompanying drawings which are provided solely for purposes of illustration without restricting the scope of the invention and in which:

FIG. 1 is a schematic side view illustrating a detail of a car according to the disclosure;

FIG. 2 is a schematic perspective view illustrating a detail of a car according to the disclosure;

FIG. 3 illustrates an embodiment of a seat according to the disclosure;

FIG. 4 illustrates an embodiment of a seat according to the disclosure and is partly in blocks;

FIG. 5 illustrates an embodiment of a seat according to the disclosure.

### DETAILED DESCRIPTION OF PREFERRED EMBODIMENTS OF THE INVENTION

With reference to the accompanying drawings, the numeral 1 denotes a seat according to this disclosure.

The seat 1 is intended for a vehicle, preferably a sports or super sports cars, preferably a two-seater.

An example car is schematically and partly illustrated in the accompanying drawings and is denoted by the numeral 100.

The car 100 comprises an interior 101 delimited at least partly by a bottom wall 102 and a rear wall 103.

In a preferred embodiment, the car 100 comprises a shell, for example, a monocoque, which comprises the walls 102 and 103.

In an embodiment, the wall 102 defines the bottom of the shell and the wall 103 a rear partition of the shell.

In an embodiment, the car 100 comprises a monocoque which is formed also of the walls 102 and 103.

The car 100 comprises at least one seat 1 mounted in the interior 101 and a pedal assembly 104. Preferably, the pedal assembly 104 is fixed, that is to say, not adjustable in position.

The seat 1 is of the type described hereinafter and comprises a sitting portion 2 and a backrest 3.

The sitting portion 2 and the backrest 3 are free of each other, that is to say, the backrest 3 is not connected to the sitting portion 2 and the sitting portion 2 is not connected to the backrest 3.

More specifically, the sitting portion 2 is fixable to the car 100 independently of the backrest 3.

In the examples illustrated, the sitting portion 2 is fixed to the car 100 and comprises, for example, a cushion 2a.

In an embodiment, the sitting portion is fixed directly to the car 100, specifically to the bottom wall 102 thereof. The expression “fixed directly” is used to mean that there are no interposed structures or mechanisms.

In an embodiment, the cushion 2a of the sitting portion 2 is interchangeable so that it can be selected by the user based on personal requirements.

The seat 1 comprises a supporting system 4 for the backrest 3, configured for installing and supporting the backrest 3 in the vehicle 100.

In the examples illustrated, the backrest 3 is fixed to the wall 103.

More specifically, the wall 103 comprises a part 105 to which the backrest 3 is fixed by means of the supporting system 4.

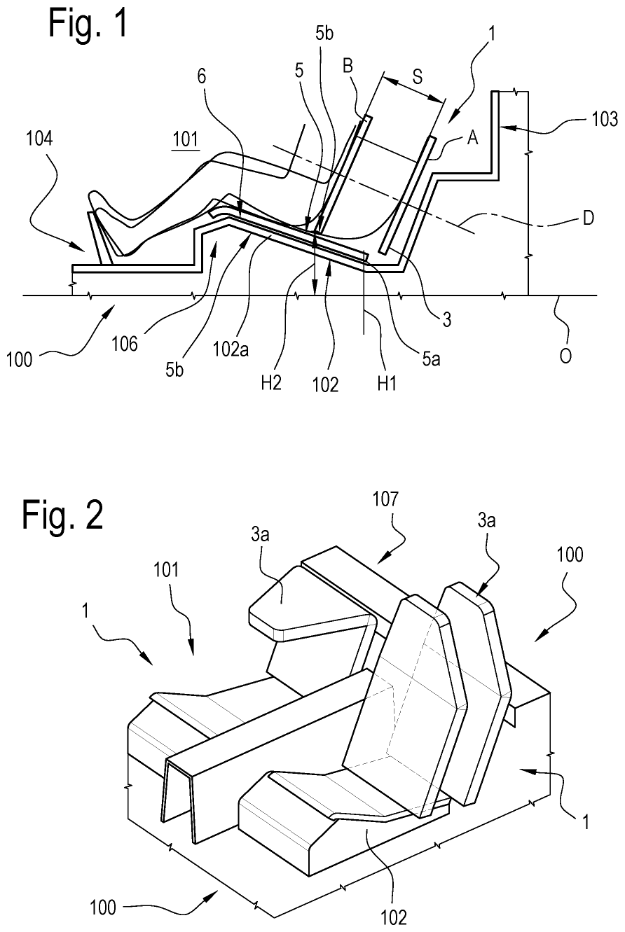

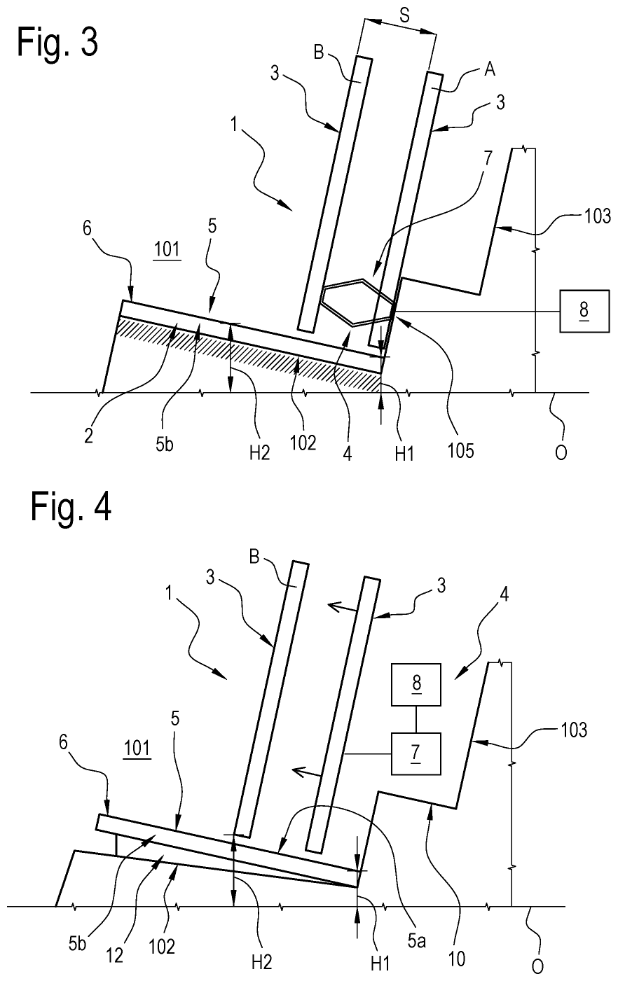

The backrest 3 is movable along the top of the sitting portion 2, by means of the supporting system 4, between a retracted position A, illustrated for example in FIGS. 1 and 3, and a forward position, denoted by the character B and illustrated for example in FIGS. 1, 3 and 4.

The retracted position A and the forward position B are identified by a front face of the backrest 3.

The distance covered by the backrest 3 between the positions A and B is denoted as travel S.

The position of the backrest 3 determines the position of the H-point of the seat 1; the H-point, as defined, for example, in SAE J4002, is fixed relative to the backrest 3 and movable relative to the sitting portion 2.

The position of the backrest 3 determines the H-point travel path in the vehicle 100.

The position of the backrest 3 limits the space that is available to the user of the seat 1 on the sitting portion 2.

This space has a maximum length MAX when the backrest is at the retracted position A and a minimum length MIN when the backrest is at the forward position B.

The sitting portion 2 comprises a supporting part 5 for supporting a user's buttocks.

The sitting portion 2, preferably the part 5 thereof, has a first height H1 relative to a horizontal reference O, at an end 5a of the sitting portion 2.

The sitting portion 2, preferably the part 5 thereof, has a second height H2 relative to the horizontal reference O, in a section 5b on the side opposite the end 5a.

For simplicity, it is assumed that the backrest 3 is positioned substantially at the end 5a when it is at the retracted position A.

For simplicity, it is assumed that the backrest 3 is positioned substantially in the section 5b when it is at the forward position B.

This simplification does not take into account the dimensions of the part 5 of the sitting portion 2. Conceptually, it is the sitting portion that has height H1 relative to a horizontal reference when the backrest is at position A and height H2 relative to the horizontal reference when the backrest is at position B.

The height H2 is greater than the height H1 and thus, when the backrest 3 is at the retracted position, a user of the seat 1 sits lower down than when the user sits on the same seat with the backrest at the forward position.

Advantageously, with reference, for simplicity, to the driver of the vehicle 100, the viewing point of a tall driver using the backrest at the most retracted position will be optimally positioned in the same way as that of a shorter driver using the backrest positioned further forward.

Thanks to the shape of the sitting portion, specifically of the part 5 thereof, moving the backrest causes an upward movement also of the driver's position and thus, the locus of the viewing points is optimized even if the drivers differ in height and the sitting portion is fixed in the vehicle.

The position of the backrest 3 relative to the sitting portion 2 identifies an end of the supporting part 5 on the sitting portion 2 itself.

The sitting portion comprises a second supporting part 6 which supports at least part of the user's legs and which preferably complements the part 5 of the sitting portion 2.

The supporting part 6 is preferably greater in length when the backrest 3 is at the retracted position A than when the backrest is at the forward position A.

The position of the backrest 3 delimits the space available to the user on the sitting portion 2. For convenience, this space is considered as coinciding with the sitting portion 2.

The sitting portion 2 comprises the parts 5 and 6 whose lengths vary in relation to the position of the backrest 3.

Advantageously, for a first user, the part 6 is longer than it is in the case of a user who is less tall than the first and who keeps the backrest at a position further forward. Both users are provided with support for their legs in proportion to their heights.

In a preferred embodiment, the height of the supporting part 5 relative to the horizontal reference increases as the backrest goes from position A to position B.

In practice, the height of the supporting part relative to a horizontal reference O increases from H1 to H2 from the end 5a to the section 5b.

The height of the supporting part 5 relative to a horizontal reference O increases from H1 to H2, that is to say, substantially from position A to position B of the backrest 3.

Preferably, the height of the sitting portion increases from the end 5a to the section 5b, that is to say, from H1 to H2 in proportion to the average height curve of a reference population.

The sitting portion is high for low percentiles and gets progressively lower as the percentiles get higher.

In an embodiment, the H-point travel path of the seat is a straight line segment that is a function of at least two height percentiles of a reference population, for example, the 50 percentile and the 95 percentile for male individuals.

In an embodiment, the H-point travel path of the seat is a straight line segment that is a function of three height percentiles of a reference population, for example, the 50 percentile and the 95 percentile for male individuals and the 05 percentile for female individuals.

In an embodiment, at least the supporting part 5 of the sitting portion 2 extends on an inclined plane or on a curved surface which can be approximated to an inclined plane whose slope increases as the backrest moves from position A to position B.

In an embodiment schematically illustrated in FIG. 4, the supporting system 4 comprises an articulated mechanism 7 which allows the backrest 3 to move from position A to position B.

In an embodiment, the seat 1, for example, the supporting system 4, comprises at least one electric drive, schematically represented as a block 8, for driving the mechanism 7.

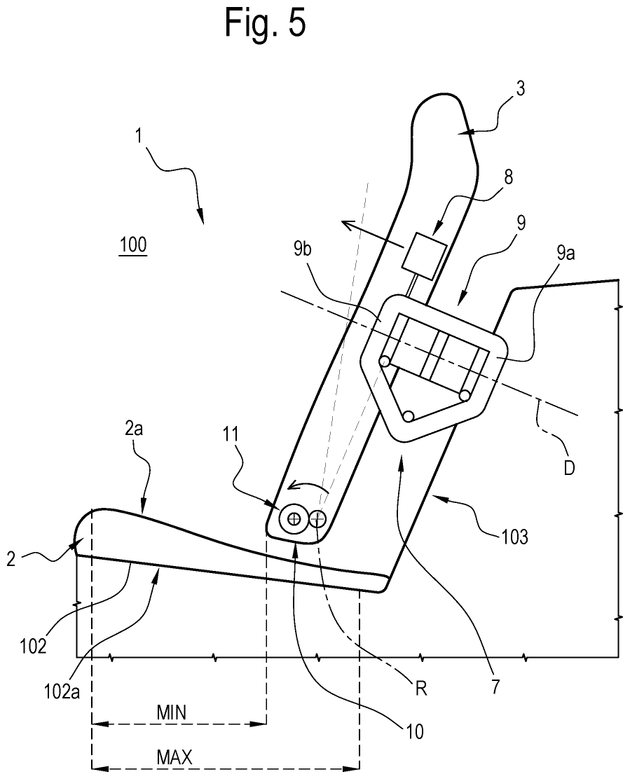

In an embodiment, illustrated for example in FIG. 5, the drive 8 is housed in the backrest 3.

In an embodiment, the drive 8 is outside the seat 1 and may not be integrated therein, as illustrated, for example, in FIG. 4.

In an embodiment, the mechanism 7 comprises a Sarrus mechanism 9 of substantially known type, capable of converting rotational motion into rectilinear motion.

The mechanism 9 comprises, for example, a first member 9a which is fixed to the wall 103, specifically to the portion 105, and a second member 9b, not illustrated, which is movable in parallel with the first member and which is fixed to the backrest 3.

Owing to the type of movement of the mechanism 9, the first and the second member 9a, 9b move towards and away from each other with rectilinear motion along a direction D of relative movement between the first and the second member of the mechanism 9.

In an embodiment, the seat 1 comprises a reclining system 10 for reclining the backrest 3.

For example, the articulated mechanism 7 comprises an articulated quadrilateral configured to allow translation and rotation of the backrest 3.

The drive 8 comprises, for example, a pair of electric motors for driving the mechanism 7 in such a way as to allow the translation and rotation of the backrest 3.

In an embodiment, the reclining system 10 is integrated in the backrest 3.

As illustrated, for example, in FIG. 5, the backrest 3 is rotatable about an axis R.

The system 10 comprises, for example, an electromechanical drive 11 which can impart to the backrest 3 a rotation about R.

In an embodiment, the seat comprises a supporting structure 12 for the sitting portion 2, and more specifically, at least for the supporting part 5.

The structure 12 may be interposed between the sitting portion and the bottom wall of the car and is configured to give the sitting portion the required inclination.

In a preferred embodiment, when the backrest 3 is at the retracted position A, the supporting structure 12 has, relative to the horizontal reference O, a first height that is lower than a second height it has when the backrest is at the forward position B.

In an example illustrated in FIG. 4, the structure 12 extends at least partly in an inclined plane which contributes to defining the inclination of the sitting portion 2.

In a preferred embodiment, a supporting structure 106 for supporting the sitting portion 2 is formed directly in the bottom wall 102 of the car interior 101.

The wall 102 is shaped in such a way that the sitting portion, and more specifically, the part that supports the user's buttocks, gets progressively higher the further it is from the rear wall of the car interior.

In an embodiment, the wall 102 is shaped in such a way as to define a base 102a for the sitting portion 2, to which the sitting portion can be fixed and preferably is fixed. The base 102a is shaped in such a way that the sitting portion positioned on the base, and more specifically, the part that supports the user's buttocks, gets progressively higher from position A to position B, relative to the horizontal reference O.

In an embodiment, the base 102a is shaped in such a way that its height relative to the horizontal reference O increases from position A to position B.

In practice, as it goes from the end 5a to the section 5b, the supporting part increases in height relative to a horizontal reference O thanks to the shape of the base wall of the car interior.

In an embodiment, as it goes from one end to the other along the direction of movement of the backrest, the base 102a increases in height relative to a horizontal reference.

Preferably, as it goes from one end to the other along the direction of movement of the backrest, the base 102a increases in height, relative to a horizontal reference, in proportion to the average height curve of a reference population.

The structure 12 and/or the structure 106 and/or the shape of the sitting portion 2, each by itself or in combination, contribute to defining the H-point travel path in the vehicle 100 based on the position of the backrest 3 relative to the sitting portion 2.

According to an aspect of the invention, the H-point travel path is a line segment which, in a preferred embodiment, is a function of at least two height percentiles of a reference population.

In an embodiment of the car 100, there is defined, under the base 102a, a compartment 106 that may be used, for example, to house batteries, electronic control units or other items.

In an embodiment, a seat 1 comprises a backrest 3 having an upper end part 3a, movable between a first working position, shown for example in FIG. 2, for the driver's seat of a car with left-hand drive, and a second working position, shown in the same drawing, for the passenger's seat that is reclined relative to the first working position.

In an embodiment, the passenger's seat of the car 100 is provided with the movable upper end part 3a.

1. A vehicle seat comprising a sitting portion and a backrest which is disconnected from the sitting portion, the sitting portion being fixable to a vehicle independently of the backrest,
the seat comprising a backrest supporting system configured for installing the backrest in the vehicle and supporting the backrest,
the backrest being movable along the sitting portion by means of the supporting system between a retracted position and a forward position,
the sitting portion being configured in such a way that, in use, when the backrest is at the retracted position, a user is seated lower down than when the backrest is at the forward position.

2. The seat according to claim 1, wherein the sitting portion comprises a first part which, relative to a horizontal reference, when the backrest is at the retracted position, has a first height that is lower than a second height it has when the backrest is at the forward position.

3. The seat according to claim 2, wherein the first part defines at least one part for supporting the user's buttocks.

4. The seat according to claim 2, wherein the first part, with the movement from the retracted position of the backrest to the forward position of the backrest, increases in height relative to the horizontal reference.

5. The seat according to claim 2, wherein at least the first part of the sitting portion extends on an inclined plane or on a curved surface which can be approximated to an inclined plane.

6. The seat according to claim 1, wherein the sitting portion comprises a second part for at least part of the user's legs, the second part being greater in length when the backrest is at the retracted position than when the backrest is at the forward position.

7. The seat according to claim 1, comprising a first supporting structure for supporting the sitting portion.

8. The seat according to claim 7, wherein the first supporting structure has, when the backrest is at the retracted position, a first height that is lower than a second height it has when the backrest is at the forward position.

9. The seat according to claim 7, wherein the supporting structure, with the movement from the retracted position of the backrest to the forward position of the backrest, increases in height relative to the horizontal reference.

10. The seat according to claim 1, wherein the supporting system is fixed to a rear face of the backrest.

11. The seat according to claim 1, wherein the supporting system comprises a Sarrus mechanism.

12. The seat according to claim 1, wherein the H-point travel path of the seat is, in use, a straight line segment that is inclined relative to a horizontal reference.

13. The seat according to claim 1, wherein the H-point travel path of the seat is, in use, a segment that is a function of at least two height percentiles of a reference population.

14. The seat according to claim 1, wherein the backrest has an upper end part that is movable between a first working position and a second working position that is reclined relative to the first working position.

15. The seat according to claim 14, wherein, the upper end part, at the second working position, is reclined towards the sitting portion.

16. A vehicle comprising an interior delimited, at least partly, by a bottom wall and a rear wall and at least one seat mounted inside the interior, the seat comprising a sitting portion and a backrest, disconnected from the sitting portion,
the sitting portion being connected directly to the bottom wall and the backrest being connected to the rear wall by a supporting system configured for installing the backrest in the vehicle and supporting the backrest, the backrest being movable along the sitting portion by means of the supporting system between a retracted position and a forward position, the bottom wall being configured in such a way that when the backrest is at the retracted position, the H-point of the seat is lower down than when the backrest is at the forward position, so that a user is seated lower down on the sitting portion when the backrest is at the retracted position than when the backrest is at the forward position.

17. The vehicle according to claim 16, comprising a shell that delimits the interior, wherein the bottom wall and the rear wall at least partly define the shell.

18. The vehicle according to claim 17, wherein the shell is made of composite materials.

19. The vehicle according to claim 16, comprising a supporting structure for supporting the sitting portion.

20. The vehicle according to claim 19, wherein the bottom wall is shaped to at least partly define the supporting structure.

21. The vehicle according to claim 16, wherein the bottom wall is shaped to define a base to which the sitting portion is fixed.

22. The vehicle according to claim 21, wherein the base is shaped in such a way that the sitting portion disposed on the base increases in height relative to a horizontal reference, with the movement from the retracted position of the backrest to the forward position of the backrest.

23. The vehicle according to claim 21, wherein the base (102a) is shaped in such a way as to increase in height relative to a horizontal reference, with the movement from the retracted position of the backrest to the forward position of the backrest.

24. The vehicle according to claim 21, wherein the base, relative a horizontal reference, when the backrest is at the retracted position, has a first height that is lower than a second height it has when the backrest is at the forward position.

25. The vehicle according to claim 16, wherein the H-point travel path of the seat is a straight line segment that is inclined relative to a horizontal reference.

26. The seat according to claim 16, wherein the H-point travel path of the seat is a segment that is a function of at least two height percentiles of a reference population.

27. The vehicle according to claim 16, comprising a housing compartment under the sitting portion.

28. A vehicle comprising a the seat is according to claim 1.
